(19) United States
(12) Patent Application Publication
(10) Pub. No.: US 2009/0029063 A1
(43) Pub. Date: Jan. 29, 2009

(54) Resin Film Forming Device, Method and Program of the Same

(76) Inventors: Hideyuki Kokaji, Tokorozawa-shi (JP); Naoto Ozawa, Tokyo (JP)

Correspondence Address: KENYON & KENYON LLP, ONE BROADWAY, NEW YORK, NY, 10004, US

(21) Appl. No.: 12/223,663

(22) PCT Filed: Feb. 5, 2007
(86) PCT No.: PCT/JP2007/051934

§ 371 Date: Aug. 5, 2008

(30) Foreign Application Priority Data
Feb. 7, 2006 (JP) 2006-029211

(51) Int. Cl. B05D 3/06; B05C 13/00

(52) U.S. Cl. 427/532; 118/620

(57) ABSTRACT

A resin film forming device is provided which includes a spinner on which a circular disc having a hole at the center thereof is mounted, the spinner making the disc spin about the hole; a resin supply unit which applies resin around the hole of the disc; and a light irradiation unit which irradiates the resin on the disc mounted on the spinner with light to cure the resin, the light irradiation unit shifting a light irradiation position from an inner circumference side toward an outer circumference side of the disc mounted on the spinner, and stopping the light irradiation before the light irradiation unit reaches the outer circumference of the disc.

### TECHNICAL FIELD

The present invention relates to a resin film forming device for forming a resin film on a disc, a method of forming a resin film, and a program for controlling the resin film forming device. More particularly, the present invention relates to a resin film forming device, a method of forming a resin film and a program in which resin can be re-used.

Priority is claimed on Japanese Patent Application No. 2006-029211, filed Feb. 7, 2006, the content of which is incorporated herein by reference.

### BACKGROUND ART

Optical discs have been developed from compact discs (CDs) into digital versatile discs (DVDs) and into next generation DVDs. The recording density has increased accordingly. In the optical discs, fine pits and lands are formed in a spiral groove on a surface of, for example, a polycarbonate substrate. When scanning the pits and lands with laser beam, recorded information is read out. If information is recorded on a single substrate as in a CD, a recording surface is protected with a resin coating. A DVD is fabricated by bonding two or more substrates together, each having a recording surface, using adhesive resin so as to increase recording density.

Application of coating resin or adhesive resin on a substrate surface generally includes applying the resin circularly near a center hole of the substrate, and making the substrate spin at high speed to spread the resin out into uniform thickness. The spread resin is then irradiated with light sequentially from a center side toward an outer circumference so as to cure the resin (see pages 11 to 13 and FIG. 1 of Patent Document 1).

### [Patent Document 1] Japanese Unexamined Patent Application, First Publication No.

### DISCLOSURE OF INVENTION

When resin applied on a disc is to be spread out and cured while the disc is spinning at high speed, the resin spread and reached an outer circumference of the disc is partially blown off due to high-speed spinning. If the resin blown off has been subject to light irradiation, the characteristics, such as absorbance and viscosity, of the resin have varied. As a result, it is difficult to re-use the resin, and the resin is wasted. In view of the aforementioned, an object of the invention is to provide a resin film forming device, a method of forming a resin film, and a program readable by a control device for controlling the resin film forming device. In the device, method and program, resin can be re-used.

To achieve the above object, a resin film forming device according to a first aspect of the invention includes: as shown in FIGS. 1 and 3 for example, a spinner 16 (16A, 16B) on which a circular disc 1 having a hole 2 at the center thereof is mounted, the spinner 16 (16A, 16B) making the disc 1 spin about the hole 2; a resin supply unit 13 which applies resin 3 around the hole 2 of the disc 1; and a light irradiation unit 17 (17A, 17B) which irradiates the resin 3 on the disc 1 mounted on the spinner 16 with light to cure the resin 3, the light irradiation unit 17 (17A, 17B) shifting a light irradiation position from an inner circumference side toward an outer circumference side of the disc 1 mounted on the spinner 16, and stopping the light irradiation before the light irradiation unit 17 (17A, 17B) reaches the outer circumference of the disc 1.

With this configuration, since the light irradiation is stopped before the irradiation unit reaches the outer circumference, the resin escaping from the disc is not irradiated with light. The characteristics, such as absorbance and viscosity, of the escaping resin are not influenced by the light, and thus the resin can be re-used. The concept of “curing resin” used herein includes complete curing of the resin. In addition, the concept may also include curing resin to an extent that the resin is not completely cured and is gelled and no more spread out toward the outer circumference by centrifugal force caused by further spinning of the disc (hereinafter, referred to as “semi-curing”).

In a resin film forming device according to a second aspect of the invention, as shown in FIG. 3 for example, in the above-described resin film forming device, the light irradiation unit 17 may be configured to continuously shift a light irradiation position from the inner circumference side toward the outer circumference side of the disc 1 mounted on the spinner 16.

With this configuration, since the light irradiation position is continuously shifted from the inner circumference side toward the outer circumference side of the disc, the resin becomes gradually cured from the inside toward the outer circumference, and thus only the resin that has not been subject to light irradiation escapes from the circumference of the disc.

In a resin film forming device according to a third aspect of the invention, as shown in FIGS. 3 and 5 for example, in the above-described resin film forming device, the spinner 16 makes the disc 1 spin at first spin speed V3 to spread the resin 3 applied around the hole 2, and then makes the disc 1 spin at second spin speed slower than the first spin speed V3; and the light irradiation unit 17 may begin irradiating the disc 1 with light while the spinner 16 spins the disc 1 at the second spin speed.

With this configuration, the resin is spread quickly and uniformly on the disc while the disc is spinning at the first spin speed. After that, the spin speed is change from the first spin speed to the second spin speed which is slower than the first spin speed. Thus, the speed at which the resin moves toward the outer circumference of the disc decreases. Since the resin is irradiated with light in this state, the resin irradiated with light can be prevented from moving toward the outer circumference of the disc.

A resin film forming device according to a fourth aspect of the invention may further include, as shown in FIG. 2 for example, in the above-described resin film forming device, a disc alignment unit 14 which places, on the disc 1 having thereon the resin 3 applied by the resin supply unit, another disc 1′ from a side at which the resin 3 is given.

With this configuration, two or more substrates having recording surfaces to increase recording density can be fabricated for, for example, a DVD. Also in this case, the adhesive resin for bonding the two or more substrates together having recording surfaces can be re-used.

A resin film forming device according to a fifth aspect of the invention may further include, as shown in FIG. 3 for example, in the above-described resin film forming device, a resin suction units 41 to 43 for sucking the resin 3 escaping from the disc 1 mounted on the spinner 16. Here, the term “escaping” means that the resin is released from the disc, and the term also includes scattering of the resin due to spin of the disc and dropping of the resin from the circumference of the disc.

With this configuration, the resin escaping from the disc can be reliably collected, thereby increasing a re-use ratio of the resin.

A resin film forming device according to a sixth aspect of the invention may further include, as shown in FIG. 1 for example, in the above-described resin film forming device 100, a curing unit 21 which re-irradiates the resin 3 with light, the resin 3 having been spread and irradiated with light by the light irradiation unit 17.

With this configuration, the light irradiation position is shifted from the inner circumference side toward the outer circumference side of the disc and irradiation of light is stopped before the irradiation unit reaches the outer circumference. Thus, the resin which has not been completely cured and the resin which is located at the outermost circumference of the disc and has not cured are cured by the moving irradiation light. The cured resin is used as adhesive resin, or cured resin as a protection film.

To achieve the above object, a method of forming a resin film according to a seventh aspect of the invention includes: as shown in FIG. 10 for example, a resin supply process S10 in which resin is applied on a circular disc, around a hole formed at the center of the disc; a first spinning process S30 in which the disc with the resin applied thereon in the resin supply process S10 is spun at first spin speed; after the first spinning process S30, a reduction process S40 in which the spin speed is reduced; during or after the reduction process S40, a light irradiation processes S50 and S60 in which the resin is cured while an irradiation position at which the resin is cured by light is shifted from the center toward an outer circumference side of the disc; and a light irradiation stopping process S70 in which irradiation of light is stopped before the outer circumference of the disc is irradiated with light.

With this configuration, the circular disc with the resin applied thereon is spun at the first spin speed to spread the resin quickly and uniformly on the circular disc. Then the spin speed is reduced, and the resin is irradiated with light for curing while the irradiation position of the light is shifted from the center toward the outer circumference side of the disc. Then, irradiation of light is stopped before the outer circumference of the disc is irradiated with light. In this manner, the resin escaping from the circumference of the disc is not irradiated with light, and the characteristics, such as absorbance and viscosity, of the escaping resin are not influenced by the light. Thus, the resin can be re-used.

A method of forming a resin film according to an eighth aspect of the invention may further include, as shown in FIG. 10 for example, in the above-described method of forming a resin film, a resin collection process S80 in which the resin applied to the disc and escapes from the disc is collected.

With this configuration, since the resin escaping from the disc is collected, the resin can be re-used and is not wasted.

A ninth aspect of the invention may further include a second light irradiation process S100 after the light irradiation stopping process S70 in the above-described method of forming a resin film. As shown in FIG. 10 for example, the resin is irradiated with light for curing the resin in the second light irradiation process S100.

With this configuration, the light irradiation position is shifted from the inner circumference side toward the outer circumference side of the disc, and irradiation of light is stopped before the irradiation unit irradiates the outer circumference of the disc. Thus, the resin which has not been completely cured and the resin which is located at the outermost circumference of the disc and has not cured can be cured by the moving irradiation light. The cured resin is used as adhesive resin, or cured resin as a protection film.

To achieve the above object, a program according to a tenth aspect of the invention is a program for controlling the resin film forming device 100 which forms a resin film on a circular disc having a center hole as shown in FIGS. 1 and 10 for example. The program executes the following steps: a resin application step S10 in which the resin is applied around a hole of a disc; a spinning step S30 in which the spinner 16 on which the disc with resin applied thereon is mounted is spun at first spin speed; after the spinning step S30, a reduction step S40 in which the spin speed of the spinner 16 is reduced; after the reduction step S40, a light irradiation steps S50 and S60 in which the disc is irradiated with light from the inner circumference side toward the outer circumference side of the disc; and a light irradiation stopping step S70 in which irradiation of light is stopped before the outer circumference of the disc is irradiated with light.

With this configuration, since irradiation of light is stopped before the outer circumference of the disc is irradiated with light. In this manner, the resin escaping from the circumference of the disc is not irradiated with light, and the characteristics, such as absorbance and viscosity, of the escaping resin are not influenced by the light. Thus, the resin can be re-used.

The resin film forming device includes: a spinner on which a circular disc having a center hole is mounted, the spinner spinning the disc about the hole; a resin supply unit which applies resin onto the disc around the hole; a light irradiation unit which irradiates the resin on the disc mounted on the spinner with light for curing the resin, the light irradiation unit shifting a light irradiation position from an inner circumference side toward an outer circumference of the disc mounted on the spinner, and stopping irradiation of light before the irradiation point reaches the outer circumference of the disc. With this configuration, since irradiation of light is stopped before the irradiation unit reaches the outer circumference, the resin escaping from the disc is not irradiated with light, and the characteristics, such as absorbance and viscosity, of the escaping resin are not influenced by the light. Thus, the resin can be re-used.

The method of forming a resin film includes: a resin supply process in which resin is applied on a circular disc, around a hole formed at the center of the disc; a first spinning process in which the disc with the resin applied thereon in the resin supply process is spun at first spin speed; after the first spinning process, a reduction process in which the spin speed is reduced; during or after the reduction process, a light irradiation process in which the resin is cured while an irradiation position at which the resin is cured by light is shifted from the center toward an outer circumference side of the disc; and a light irradiation stopping process in which irradiation of light is stopped before the outer circumference of the disc is irradiated with light. With this configuration, the circular disc with the resin applied thereon is spun at the first spin speed to spread the resin quickly and uniformly on the circular disc. Then the spin speed is reduced, and the resin is irradiated with light for curing while the irradiation position of the light is shifted from the center toward the outer circumference side of the disc. Then, irradiation of light is stopped before the outer circumference of the disc is irradiated with light. In this manner, the resin escaping from the circumference of the disc is not irradiated with light, and the characteristics, such as absorbance and viscosity, of the escaping resin are not influenced by the light. Thus, the resin can be re-used.

In addition, the program readable by a control device for controlling the resin film forming device which forms a resin film on a circular disc having a center hole executes the following steps: a resin application step in which the resin is applied around a hole of a disc; a spinning step in which the spinner on which the disc with resin applied thereon is mounted is spun at first spin speed; after the spinning step, a reduction step in which the spin speed of the spinner is reduced; after the reduction step, a light irradiation step in which the disc is irradiated with light from the inner circumference side toward the outer circumference side of the disc; and a light irradiation stopping step in which irradiation of light is stopped before the outer circumference of the disc is irradiated with light. With this configuration, since irradiation of light is stopped before the outer circumference of the disc is irradiated with light. In this manner, the resin escaping from the circumference of the disc is not irradiated with light, and the characteristics, such as absorbance and viscosity, of the escaping resin are not influenced by the light. Thus, the resin can be re-used.

The invention may alternatively include the following structures. The invention is a resin film forming device in which the light irradiation unit includes: a light irradiation portion; an arm which supports the light irradiation portion; and a pivot driver which supports the arm, makes the aim pivot and travel from the inner circumference side toward the outer circumference side of the spinning disc.

With this configuration, an effect is advantageously provided that the pivotal movement facilitates continuous movement, in its precise sense, of the light irradiation unit. In addition, an effect is also advantageously provided that the shifting speed of the light irradiation position can be adjusted by the speed of the pivotal movement.

The invention is the above-described resin film forming device, in which the light irradiation unit includes: a light irradiation portion; an arm which supports the light irradiation portion; a pivot driver which supports the arm, makes the arm pivot and travel from the inner circumference side toward the outer circumference side of the spinning disc; and a vertical driver connected to the pivot driver, for moving the arm upward to move the light irradiation portion upward when the light irradiation portion reaches the outer circumference of the disc.

In this configuration, since the distance between the disc and the light irradiation portion becomes long when the arm is moved upward, similar effect to the stopping of light irradiation can be obtained.

The invention is a method of forming a resin film, which includes: a process of mounting a circular disc having a center hole on a spinner, and making the disc spun about the hole; a process of applying resin onto the disc around the hole; a process of irradiating the disc with light while an irradiation position is shifted from an inner circumference side toward an outer circumference side of the disc mounted on the spinner; and a process of stopping irradiation of light before the light irradiation reaches the outer circumference of the disc.

With this configuration, since irradiation of light is stopped before the light irradiation reaches the outer circumference, the resin escaping from the disc is not irradiated with light, and the characteristics, such as absorbance and viscosity, of the escaping resin are not influenced by the light. Thus, the resin can be re-used.

### BRIEF DESCRIPTION OF THE DRAWINGS

FIG. 1 is a plan view illustrating a structure of a resin film forming device according to the invention.

FIG. 2A is a side view illustrating an overall structure and motion of a disc alignment unit.

FIG. 2B is a partially enlarged cross-sectional view illustrating a state in which the disc alignment unit sucks and holds a disc substrate.

FIG. 3 is a partial cross-sectional block diagram illustrating a spinner, a light irradiation unit, a coater house for catching resin escaping from the disc mounted on the spinner, a resin suction unit for sucking the resin caught on the coater house, and a control unit.

FIG. 4 is a perspective view illustrating travelling of an irradiating section of the light irradiation unit.

FIG. 5 is a time series graph showing a relationship between a spin speed of the disc spinning on the spinner and an ultraviolet irradiation position of the light irradiation unit.

FIG. 6 is a schematic view showing a relationship between a spreading speed of the resin due to spin of the disc and a speed at which the ultraviolet irradiation position is moved.

FIG. 7 is a time series graph showing a relationship between a spin speed of the disc spinning on the spinner and an ultraviolet irradiation position of the light irradiation unit.

FIG. 8 is a partial cross-sectional block diagram illustrating a spinner, a light irradiation unit, a coater house for catching resin escaping from the disc mounted on the spinner, a resin suction unit for sucking the resin 3 caught on the coater house, and a control unit.

FIG. 9 is a partial cross-sectional block diagram illustrating a spinner, a light irradiation unit, a coater house for catching resin escaping from the disc mounted on the spinner, a resin suction unit for sucking the resin caught on the coater house, and a control unit.

FIG. 10 is a flow chart illustrating a main part of the method of forming a resin film according to the invention.

FIG. 11A is a graph showing distribution at radius positions of the resin film on the disc formed in accordance with a conventional method.

FIG. 11B is a graph showing distribution at radius positions of the resin film on the disc formed in accordance with the invention.

FIG. 12 is a graph illustrating comparison among absorbance characteristics of resin in an ultraviolet region in which: curve A represents absorbance of an unused resin; curve B represents absorbance of resin escaping from a disc and collected in a process of resin film formation according to the invention; and curve C represents absorbance of resin irradiated with ultraviolet light to an extent that the resin is not cured.

### DESCRIPTION OF THE REFERENCE SYMBOLS

1, 1′: disc substrates, 2: hole, 3: resin, 4, 5: optical disc, 10: disc mounting arm, 11: turn table, 11a, 11b: receiving part, 12: inversion unit, 13: resin supply unit, 13a: supply nozzle, 14: disc alignment unit, 15: transfer unit, 16 (16A, 16B): spinner, 16a: receiver, 16b: spinning axis, 16c: spin driver, 17 (17A, 17B): light irradiation unit, 18: receiver, 19: transfer unit, 20: turn table, 21: curing unit, 22: turn table, 23: inversion unit, 24: electric discharger, 25: transfer unit, 26: inspection unit, 27: lifting stage, 28: transfer unit, 29; non-defective article table, 30: defective article table, 40: coater house, 41: suction pipe, 42: resin reservoir, 43: suction unit, 46: shutter, 60: control unit, 111: disc receiver, 112: projection, 113: notch, 140: column, 141: arm, 142: suction unit, 143: suction surface, 144: vacuum section, 145: Suspending portion, 146: vacuum tube, 171: irradiation unit, 172: irradiation arm, 173: vertical driver, 174: pivot driver, 175: optical fiber, 176: ultraviolet light source, 178: irradiation control unit, 180: light irradiation unit, 181: LED, 188: LED control unit, R1: position at inner circumference side of disc where ultraviolet light irradiation is started, R2: position at outer circumference side of disc where irradiation of ultraviolet light is stopped, V1, V2, V3: spin speed of disc

### BEST MODE FOR CARRYING OUT THE INVENTION

Hereinafter, embodiments of the invention will be described with reference to the drawings. In the drawings, identical reference numerals are given to the identical or corresponding devices, and repeated description thereof will be omitted.

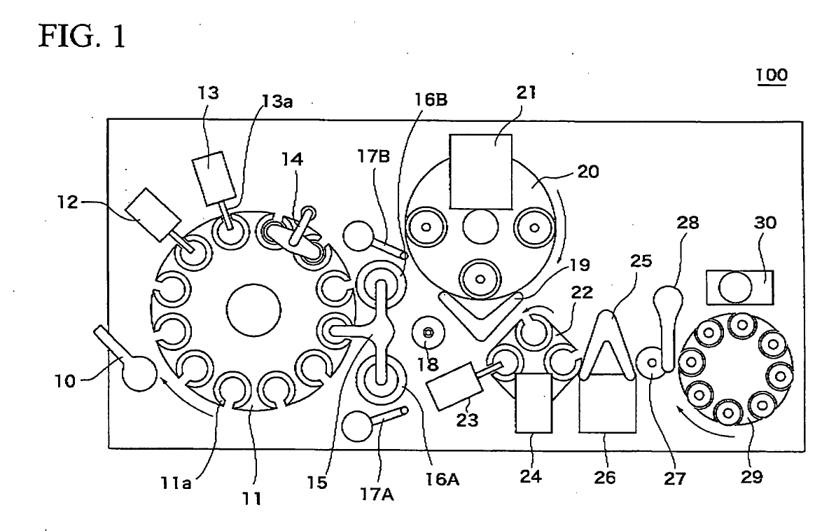

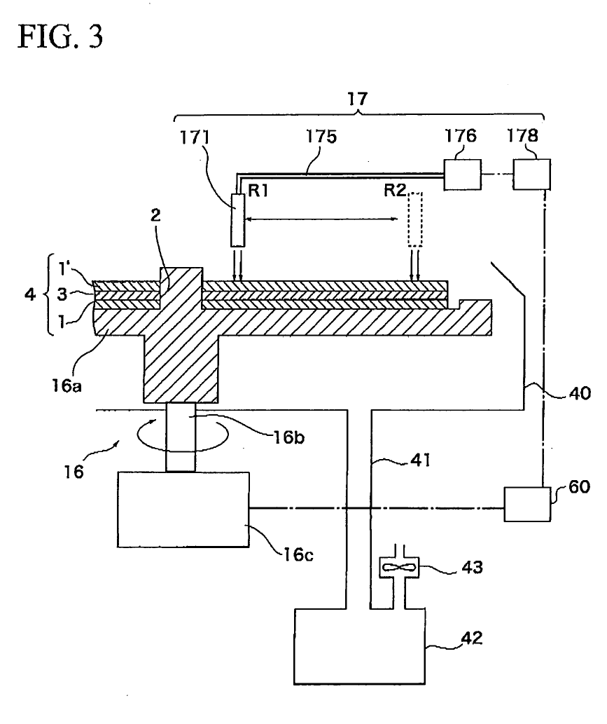

First, a resin film forming device 100 according to the invention will be described with reference to FIG. 1. FIG. 1 is a plan view illustrating a structure of the resin film forming device 100 according to the invention. The resin film forming device 100 includes a disc mounting arm 10, a turn table 11, an inversion unit 12, a resin supply unit 13, a disc alignment unit 14, a transfer unit 15, spinners 16A and 16B, and light irradiation units 17A and 17B. The disc mounting arm 10 mounts the disc substrate 1 (see FIG. 3) on a receiving part 11a of the turn table 11. The turn table 11 sends the disc substrate 1 mounted on the receiving part 11a to processing. The inversion unit 12 inverts the disc substrate 1 placed on the receiving part 11a. The resin supply unit 13 applies resin to the disc substrate 1 around the hole 2 (see FIG. 3). The disc alignment unit 14 places a disc substrate 1′ (see FIG. 3) on the disc substrate 1 onto which the resin 3 has been applied. The transfer unit 15 transfers a disc 4 (see FIG. 3) consisting of the disc substrates 1 and 1′ bonded together with the resin 3 from the turn table 11 to the spinners 16A and 16B, and from the spinners 16A and 16B to a receiver 18. The spinners 16A and 16B cause the disc 4 to spin about the hole 2. The light irradiation units 17A and 17B irradiate the disc 4 on the spinners 16A and 16B with light. Here, the spinners 16A and 16B and the light irradiation units 17A and 17B are provided in two series. This is because it takes time to make the disc 4 spin on the spinners 16A and 16B and to irradiate light by the light irradiation units 17A and 17B. With this structure, working efficiency of the overall resin film forming device 100 improves. The spinners 16A and 16B and the light irradiation units 17A and 17B may alternatively be provided in one series, or in more than three series. In a one series structure, the resin film forming device 100 is made simple, compact and lightweight. When spinning of the disc 4 and irradiation of light take time, working efficiency of the overall resin film forming device 100 can be improved by providing three or more series of the spinners 16A and 16B and the light irradiation units 17A and 17B. Hereinafter, when the two-series spinners and light irradiation units are to be distinguished, they will be described as spinners 16A and 16B and light irradiation units 17A and 17B, but when they need not to be distinguished, they will be described as the spinner 16 and the light irradiation unit 17.

The resin film forming device 100 also includes a receiver 18, a transfer unit 19, a turn table 20, a curing unit 21, a turn table 22, an inversion unit 23, an electric discharge unit 24, a transfer unit 25, an inspection unit 26, a lifting stage 27, a transfer unit 28, a non-defective article table 29 and a defective article table 30. The disc 4 irradiated with light is temporarily placed on the receiver 18. The transfer unit 19 transfers the disc 4 from the receiver 18 to the turn table 20 and from the turn table 20 to the turn table 22. The turn table 20 transfers the disc 4 to the curing unit 21. The curing unit 21 re-irradiates the disc 4 on the turn table 20 with light, thereby completely curing the entire resin 3. The turn table 22 moves the disc 4 to the inversion unit 23 and to the electric discharge unit 24. The electric discharge unit 24 discharges the disc 4 and the inversion unit 23 which inverts the disc 4. The transfer unit 25 transfers the disc 4 from the turn table 22 to the inspection unit 26 and from the inspection unit 26 to the lifting stage 27. The inspection unit 26 inspects the disc 4. The lifting stage 27 lifts the disc 4 to the height of the transfer unit 28. The transfer unit 28 transfers the disc 4 from the lifting stage 27 to the non-defective article table 29 and to the defective article table 30. Discs 4 defined as non-defective articles in the inspection are placed on the non-defective article table 29. Discs 4 defined as defective articles in the inspection are placed on the defective article table 30.

The disc substrates 1 and 1′ are typically polycarbonate resin-made discs, but not limited thereto. Other materials that transmit laser beam may be used suitably. The disc substrate 1 is a circular thin board, which has a circular hole 2 in the center thereof. The disc is typically circular-shaped, but not limited thereto. For example, the disc substrate 1 is 120 mm in diameter and 0.6 mm in thickness. The center hole is 15 mm in diameter. However, the size may vary depending on application. Fine grooves constituting spiral grooves or signals are formed on one side of the disc substrate 1. The disc substrate 1 and the disc substrate 1 have different grooves. These disc substrates are temporary placed near the turn table 11. The disc substrate 1 and the disc substrate 1′ are alternately placed on the receiving part 11a of the turn table 11 by the disc mounting arm 10 with the groove-formed surfaces facing upward. The disc mounting arm 10 places the disc substrates 1 and 1′ on the receiving parts 11a by holding them at the hole from the inside or at the outer circumference from the outside so that the arm 10 does not contact the groove-formed surfaces.

The turn table 11 has twelve receiving parts 11a. The number of the receivers is not limited to twelve, but twelve is preferred in that the receivers come to the same position by turns as the turn table 11 intermittently rotates by 30 degrees. A central portion of the receiving part 11a is empty space, of which circular periphery is recessed to receive the disc substrate 1. The circular recess of the receiving part 11a opens to outside at the outer circumference of the turn table 11. With this structure in which the receiving part 11a opens to outside, a later-described arm of the inversion unit 12 can be inserted from the underside of the disc substrate 1 placed in the receiving part 11a.

The inversion unit 12 inverts the disc substrate 1′ placed in the receiving part 11a. In order that the two disc substrates 1 and 1′ are aligned with the groove-formed surfaces facing with each other as shown in FIG. 3, the inversion unit 12 inverts the disc substrate 1′ placed in every second receiving part 11a of the turn table 11. In the inversion unit 12, a distal end of the arm holds the disc substrate 1′ and lifts the same from the receiving part 11a. Then, the arm rotates by 180 degrees about the axis to invert the disc substrate 1′ and place it again in the receiving part 11a. The inversion unit 12 may be provided separately from the turn table 11 such that the inversion unit 12 inverts the disc substrate 1′ before the disc substrate 1′ is placed in the turn table 11.

The resin supply unit 13 applies resin circularly on the disc substrate 1 around the hole 2. In the resin film forming device 100, since the two disc substrates 1 and 1′ are bonded together, ultraviolet curing resin is used as a liquid adhesive. The resin supply unit 13 applies the resin circularly by moving a nozzle 13a over a peripheral circumference of the hole 2 to supply resin. However, the nozzle 13a may alternatively be fixed and the disc substrate 1 may rotate slowly. The resin is applied to the non-inverted disc substrate 1 by the disc inversion unit 12. That is, the resin is applied to the groove-formed surface of the disc substrate 1. The resin supply unit 13 may be provided separately form the turn table 11 so that the resin supply unit 13 applies the resin to the disc substrate 1 before the disc substrate 1 is placed in the turn table 11.

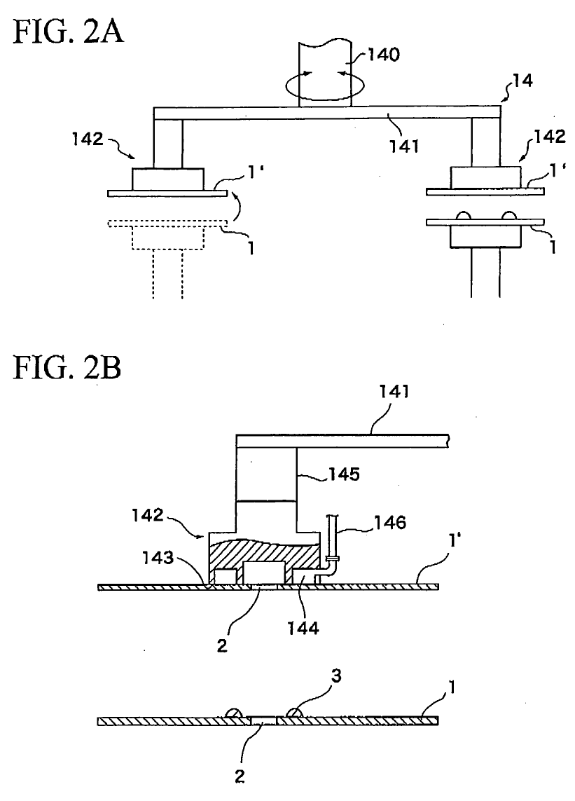

As shown in FIG. 2, the disc alignment unit 14 sucks and holds the disc substrate 1′ that has been inverted by the disc inversion unit 12, and places the disc substrate 1′ to align with the disc substrate 1 in the next receiving part 11a. FIG. 2A is a side view illustrating an overall structure and motion of the disc alignment unit 14. FIG. 2B is a partially enlarged cross-sectional view illustrating a state in which the disc alignment unit 14 sucks and holds a disc substrate 1′. The disc alignment unit 14 includes two suction units 142 which suck the disc substrate 1′, an arm 141 from which the suction units 142 are suspended, and a column 140 which hangs the arm at its center (i.e., the midpoint of two suction units 142) and rotate the army 180 degrees. The column 140 hangs the arm 141 at the center thereof via an unillustrated fixing table over the turn table 11 between the two predetermined receiving parts 11a. Each suction unit 142 is located directly above the corresponding receiving part 11a. At the position, the suction unit 142 sucks and holds the disc substrate 1′ placed in one receiving part 11a, moves the disc substrate 1′ to the next receiving part 11a while rotating the arm 141 by 180 degrees, and then places the disc substrate 1′ to align with the disc substrate 1. The arm 141 may be rotated by 180 degrees by any known method.

Here, with reference to FIG. 2B, a structure for sucking and holding the disc substrate 1′ will be described in detail. The suction unit 142 includes a suction surface 143 for sucking the disc substrate 1′. The suction surface 143 includes a vacuum section 144. The vacuum section 144 is connected with a vacuum tube 146. An unillustrated vacuum device sucks the air to suck the disc substrate 1′ to the suction surface 143. The suction surface 143 may be formed from a relatively soft material, such as hard rubber, not to damage the disc substrate 1′ while facilitating vacuum suction. The suction unit 142 includes a suspending portion 145 to suspend from the arm 141. The suspending portion 145 may be a member to simply suspend from the arm 141 so long as it includes a lifting stage for moving the disc substrate 1′ and the disc substrate 1′ upward to a required height at the time of sucking the disc substrate 1′ and placing it aligned with the disc substrate 1. However, if the turn table 11 includes no lifting table, the suspending portion 145 has a structure to extend and contract by a solenoid or other mechanism to vertically move the suction surface 143. In order to align the two disc substrates 1 and 1′ with each other, the disc substrate 1′, inverted by the disc inversion unit 12, is lifted by the lifting stage, or suction surface 143 is moved down by the suspending portion 145, so that the suction surface 143 abuts the substrate 1′ to suck and hold the same. After moving the lifting stage downward, or retracting the suspending portion 145 to remove the disc substrate 1′ upward from the receiver 11a, the arm 141 is rotated by 180 degrees to move the disc substrate 1′ onto the disc substrate 1 in the next receiver 11a. When the disc substrate 1 is lifted by the lifting stage, or the suspending portion 145 extends to move the suction surface 143, i.e., the disc substrate 1′ downward so that the disc substrate 1′ is aligned with the disc substrate 1, the disc substrate 1′ is released from suction force. When the suction force to the disc substrate 1′ is released, the lifting stage is moved downward, or the suspending portion 145 is retracted, and the suction surface 143 is released over the receiver 11a. While a disc substrate 1′ is sucked in a certain receiver 11a, a disc substrate 1 and a disc substrate 1′ are aligned together in the next receiver 11a.

In the foregoing description, the disc alignment unit 14 includes two suction units 142, and the arm 141 rotates by 180 degrees to move to the next receiver 11a. However, the disc alignment unit 14 may alternatively include only one suction unit 142 that is fixed and supported by the arm 141. The suction unit 142 may suck and hold the disc substrate 1′, and the turn table 11 may be rotated by 30 degrees. When the next disc substrate 1 is positioned directly below the suction unit 142, the suction unit 142 may align the disc substrate 1′ with the disc substrate 1 at that position. While the disc substrates 1′ is sucked, held and lifted, the turn table 11 rotates by 30 degrees and aligns the disc substrate 1′ with the disc substrate 1 placed in the next receiving part 11a. In this manner, the two disc substrates 1 and 1′ are aligned with each other. In this manner, since the disc substrate 1′ to be aligned with the disc substrate 1 from upward without moving, the disc substrate 1 and the disc substrate 1′ cannot be misaligned or rotated with each other. In a structure with two suction units 142, operating time can be reduced. In that structure, the aim 141 is rotated 180 degrees without waiting for the rotation of the turn table 11 to move the disc substrate 1′, and the disc substrate 1′ is aligned on the disc substrate 1. Note that, the structure of the disc alignment unit 14 is not limited to that illustrated to FIG. 2. Rather, any structure may be employed so long as it can lift the disc substrate 1′ and aligns it with the disc substrate 1.

The transfer unit 15 transfers the aligned disc substrates 1 and 1′ (referred to as “disc 4” altogether with the resin 3) from the receiver 11a of the turn table 11 to the spinners 16A and 16B, and from 16A and 16B to the receiver 18. The transfer unit 15 includes three arms extending perpendicularly to one another. With this configuration, the transfer unit 15 can transfer the disc 4 from the receiver 11a to the spinner 16A, from the spinner 16A to the receiver 18, and from the receiver 11a to the spinner 16B at a time. At the same time, the transfer unit 15 can transfer the disc 4 from the spinner 16B to the receiver 18. The receiver 11a, the spinner 16A, the receiver 18 and the spinner 16B are circumferentially disposed at 90 degrees from one another counterclockwise in this order. The transfer unit 15 may transfer two discs 4 at a time by two arms. However, three arms may reduce a rotation angle required to transfer the disc 4. If the transfer unit 15 has four arms, the rotation angle may further be reduced since operation for returning the transfer unit 15 to the original position can be omitted.

The spinner 16 makes the disc 4 spin in order to spread the resin 3 uniformly on the disc 4 while spinning the disc 4 at high speed, and to irradiate light from the light irradiation unit 17 on the entire surface of the disc 4. The light irradiation unit 17 is assembled to the spinner 16.

Here, also referring to FIG. 3, the spinner 16 and the light irradiation unit 17 will be described in more detail. FIG. 3 is a partial cross-sectional block diagram illustrating the spinner 16, the light irradiation unit 17, the coater house 40 for catching resin escaping from the disc 4 mounted on the spinner 16, a suction pipe 41 as the resin suction unit for sucking the resin 3 caught on the coater house 40, a resin reservoir 42, a suction unit 43, and a control unit 60. In FIG. 3, the dashed line shows a communication channel of control signals.

The Spinner 16 includes a receiver 16a, a spinning axis 16b, and a spin driver 16c. The receiver 16a receives the disc 4 and makes the disc 4 spin. The receiver 16a. Includes a circular plate on which the disc 4 is mounted, and a pillar-shaped projection at the center of the plate. The projection is inserted in the holes 2 of the disc substrates 1 and 1′. In this manner, the center of the disc 4 and the center of rotation of the receiver 16a are aligned with each other. Other than being shaped as a pillar, the projection may also be tapered to facilitate insertion in the hole 2. A pillar-shaped spinning axis 16b is disposed directly below and at an opposite side of the receiver 16a cocentrically with the receiver 16a. The other end of spinning axis 16b is connected to the spin driver 16c. The receiver 16a spins about the projection when the spin driver 16c spins. The spin driver 16c includes, for example, a motor and a gearbox for varying the spin speed of the receiver 16a. Instead of the gearbox, the spin driver 16c may include an inverter motor. Any mechanism may be employed which can rotate the receiver 16a with varying spin speed.

The coater house 40 is a container formed to surround the receiver 16a. The coater house 40 catches on the surrounding wall the resin 3 scattering from the disc 4 spinning on the spinner 16 and collects the resin 3. In addition, the coater house 40 collects the resin 3 escaping from the disc 4. The coater house 40 has an opening at the bottom thereof. A suction pipe 41 is connected with the opening to suck the resin 3 collected in the coater house 40. The other end of the suction pipe 41 is connected to a resin reservoir 42. The resin reservoir 42 is a sealed container which has an opening connected to the suction pipe 41 and an opening to be connected with a suction unit 43. The resin reservoir 42 may also include a discharge port (not shown) for sometimes discharging the resin collected in the resin reservoir 42. The discharge port is closed for normal operation. The suction unit 43 sucks air through the suction pipe 41 to such the resin reservoir 42 from the interior of the coater house 40. The suction unit 43 is typically a draft fan. The air sucked from the resin reservoir 42 by the suction unit 43 is emitted to the atmosphere. A demister (not shown) may be provided at a position where the air is sucked from the resin reservoir 42 by the suction unit 43.

The light irradiation unit 17 includes an irradiating section 171, an ultraviolet light source 176, an irradiation control unit 178 and an optical fiber 175. The irradiating section 171 emits the ultraviolet light in a spot manner as light beam to irradiate the disc with. The ultraviolet light source 176 generates the ultraviolet light to be irradiated from the irradiating section 171. The irradiation control unit 178 controls generation of the ultraviolet light in the ultraviolet light source 176. The optical fiber 175 transmits the ultraviolet light generated in the ultraviolet light source 176 to the irradiating section 171. The irradiating section 171 irradiates a surface of the disc 4 with ultraviolet light, while travelling from the position R1 at the inner circumference side around the hole 2 toward the outer circumference side of the disc 4. That is, travelling of the irradiating section 171 shifts the irradiation position of the ultraviolet light on the disc surface. The irradiating section 171 stops at a position R2 before it travels further toward the outer circumference. The irradiation of the ultraviolet light to disc 4 is completed at the position R2. Travelling of the irradiating section 171 and the irradiation of the ultraviolet light, i.e., generation of the ultraviolet light in the ultraviolet light source 176, are controlled by the irradiation control unit 178. Here, if a disc substrate having a radius of 60 mm (a diameter of 120 mm) is used, the position R1 at the inner circumference side is typically located within a range of 10 to 25 mm in radius (16 to 42% of the disc substrate radius) from the center. The position R2 at the outer circumference side is typically located within a range of 40 to 58 mm in radius (66 to 97% of the disc substrate radius) from the center.

The control unit 60 controls the timing and the spin speed at which the spin driver 16c of the spinner 16 makes the receiver 16a spin, the timing of the light irradiation unit 17 irradiate the disc with ultraviolet light, the position of the irradiating section 171 (including travelling speed), and irradiation amount. The spinner 16 spins and the light irradiation unit 17 irradiates light in a cooperative manner. The control unit 60 may control operation of the entire resin film forming device 100, and, may also control operation and stopping of the suction unit 43, for example.

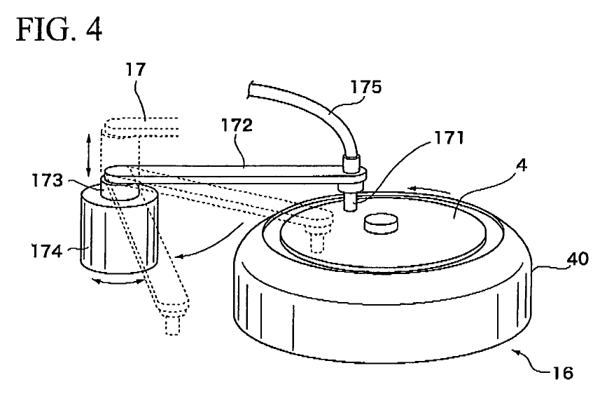

Referring again to FIG. 4, the travel of the irradiating section 171 of the light irradiation unit 17 will be described in more detail. FIG. 4 is a perspective view illustrating the travel of the irradiating section 171 of the light irradiation unit 17. The irradiating section 171 is supported by an irradiation aim 172. The irradiating section 171 may be formed as an end surface of the optical fiber 175. The irradiating section 171 may include a lens mechanism at the end surface of the optical fiber 175, and may have function for concentrating and diffusing the ultraviolet light. The irradiation arm 172 is supported by the pivot driver 174 via a vertical driver 173. The vertical driver 173 vertically moves up and down. When moving up, it removes the irradiating section 171 away from the disc 4 so that the irradiation of the ultraviolet light to the disc 4 is substantially eliminated. Here, the term “the irradiation of the ultraviolet light to the disc 4 is substantially eliminated” means that, even if the ultraviolet light is irradiated, that irradiation amount is too small to cure the resin 3, and that concept is included in the concept “irradiation is stopped”. The pivot driver 174 makes the irradiation arm 172 pivot so that the irradiating section 171 travels between the center side and the outer circumference side of the disc 4. The pivot driver 174 may be configured to travel over the outer circumference of the disc 4. The pivot driver 174 may alternatively be configured to stop before reaching the outer circumference of the disc 4, or configured such that the rotation of the pivot driver 174 may be restricted not to travel over the outer circumference of the disc 4. The optical cable for connecting the irradiating section 171 and the ultraviolet light source 176 to transmit the ultraviolet light from the ultraviolet light source 176 to the irradiating section 171 has a flexible structure. Since the optical cable is flexible, it can follow the travelling irradiating section 171 with almost no resistance.

Referring again to FIG. 1, description of the resin film forming device 100 will be continued. The receiver 18 is a base on which the disc 4, irradiated with ultraviolet light from the light irradiation units 17A and 17B by the two spinners 16A and 16B, is temporarily placed at a site. The disk 4 temporarily placed in the receiver 18 is transferred to the turn table 20 by the transfer unit 19. The transfer unit 19 includes two arms opened at a predetermined angle. When the arms are rotated, the disc 4 can be transferred from the receiver 18 to the turn table 20 and from the turn table 20 to the next turn table 22 at the same time. That is, the position at which the receiver 18 and the disc 3 of the turn table 20 is placed and removed, and the position at which the disc 4 of the receiver 22 is placed are located at equal intervals on a circle about the center of rotation of the arm of the transfer unit 19.

Four receiving parts are provided in the turn table 20 for receiving the disc 4. When the turn table 20 rotates, the disc 4 placed on the receiving parts is transferred to the curing unit 21. The turn table 20 rotates intermittently by 90 degrees to transfer the disc 4 placed thereon to the curing unit 21. The curing device 21 irradiates the entire surface of the disc 4 with ultraviolet light to completely cure the resin 3 on the disc 4. Unlike the case where the resin 3 is cured by the spinner 16 and the light irradiation unit 17, in the curing unit 21, the disc 4 can be irradiated with ultraviolet light without rotating the disc 4. The curing unit 21 has a xenon lamp which generates the ultraviolet light in pulses, or a UV generating lamp which generates the ultraviolet light continuously on one or both of the upper and lower surfaces of the turn table 20. After the resin 3 is completely cured by the curing unit 21, the disc 4 is transferred to the turn table 22 by the transfer unit 19.

Similar to the turn table 11, the turn table 22 also includes cylindrical receiving parts which open to outside at outer circumferences thereof. The turn table 22 includes four receiving parts and rotates intermittently by 90 degrees. The turn table 22 is rotated to transfer the disc 4 sequentially to the inversion unit 23 and the electric discharge unit 24. The inversion unit 23 has a similar structure to that of the inversion unit 12. The disc 4 is optionally inverted when required for later inspection process. For this reason, the receiving part of the turn table 22 also opens to outside. The electric discharge unit 24 blows ionized air off to remove dust or the like adhering to the surface of the disc 4.

The disc 4 after removing the dust or the like is transferred from the turn table 22 to the inspection unit 26 by the transfer unit 25. The transfer unit 25 includes two arms opened at a predetermined angle. By rotating the two arms, the transfer unit 25 can transfer the disc 4 from the turn table 22 to the lifting stage 27 to the inspection unit 26, and from the inspection unit 26 to the next lifting stage 27 at the same time. That is, the position at which the disc 4 is removed from the turn table 22, the position of the inspection unit 26, and the position of the lifting stage 27 are placed at equal intervals on a circle about the center of rotation of the arm of the transfer unit 25.

The disc 4 is mounted on the inspection unit 26, which inspects the disc 4 from the underside. The inspection unit 26 inspects, for example, existence of blemish on the disc substrates 1 and 1′, misalignment of the two disc substrates 1 and 1′, uniformity in the spread resin 3, and warping of the disc 4. The inspected disc 4 is transferred to the lifting stage 27 by the transfer unit 25. The lifting stage 27 includes a stage which moves up and down between the height in which the foregoing processes are performed and the height at which the product is taken out. That is, in the resin film forming device 100, the product disc 4 is taken out from an upper port. In this manner, the disc 4 is easily transferred to subsequent processes. The lifting stage 27 moves upward with the disc 4 placed thereon, and continues moving until the disc 4 contacts the suction surface (not shown) of the transfer unit 28. The transfer unit 28 includes a pivoting arm, and a suction surface for sucking the disc 4 below a distal end of the arm. According to the inspection result, the transfer unit 28, by sucking the disc 4 at the suction surface at the distal end of the arm and pivoting the arm, transfers discs 4 that passed the inspection to the non-defective article table 29, and transfers discs 4 that did not pass the inspection to the defective article table 30. The non-defective article table 29 includes eight receiving parts, and rotates intermittently by 45 degrees to receive the disc 4 as a product one at a time in each receiving part. The defective article table 30 receives the discs 4 that failed to pass the inspection and thus cannot be used as products. The discs 4 may be stacked, and the defective article table 30 may include a guide for supporting the outer periphery of the discs 4.

Next, a method of fabricating a disc 4 will be described. A resin film is formed using a resin film forming device 100, and two disc substrates 1 and 1′ are bonded together to form a disc 4. The disc substrates 1 and 1′ are separately fabricated and recording grooves are also formed separately. Then, the disc substrate 1 and the disc substrate 1′ are separately conveyed to the vicinity of the resin film forming device 100. The disc substrates 1 and 1′ are stored within the reach of the disc mounting arm 10 with the groove-formed surfaces facing upward. The disc substrate 1 and the disc substrate 1′ are alternately placed in the receiving part 11a of the turn table 11 by the disc mounting arm 10. That is, the disc substrate 1 and the disc substrate 1′ are alternately placed in the receiving part 11a of the turn table 11.

The turn table 11 rotates intermittently by 30 degrees. The inversion unit 12 does not invert the disc 1 when the disc 1 comes to the position of the inversion unit 12. The inversion unit 12 inverts the disc 1′ only when the disc 1′ comes to the position of the inversion unit 12. The resin supply unit 13 supplies resin around the hole 2 of the disc 1, when the disc 1 comes to the position of the resin supply unit 13. The resin 3 is circularly applied around the hole 2 while the supply nozzle 13a moving around the hole 2. Then, in the disc alignment unit 14, the disc 1′ which has been inverted by the inversion unit 12 is placed to align with the disc 1 having the resin 3 applied thereto. In this manner, the disc 4 is fabricated. Since the disc 1′ had been inverted, when the alignment unit 14 moves the disc 1′ to be aligned with the disc 1 in the next receiving part 11a, two discs 1 and 1′ are aligned together with the groove-formed surfaces facing with each other. Then, the disc 4 is transferred from the turn table 11 to the spinner 16 by the transfer unit 15.

When the disc 4 is mounted on the spinner 16, the spinner 16 begins to spinning with the disc 4. As shown in FIGS. 3 and 4, while disc 4 is spun, the irradiation arm 172 is made to pivot by the pivot driver 174 to position the irradiating section 171 at a position R1 at the inner circumference side. The irradiating section 171 is moved downward by the vertical driver 173 to a position where the disc 4 is irradiated with ultraviolet light of irradiation intensity sufficient to cure the resin 3. Alternatively, the irradiation intensity of the ultraviolet light may be adjusted by concentration. However, irradiation of the ultraviolet light is not started yet. Alternatively, while the ultraviolet light may be continuously irradiated, the irradiating section 171 is kept away from the disc 4 by the vertical driver 173 so that the disc 4 is substantially not irradiated with ultraviolet light. It is preferred that, when the disc 4 is placed on or removed from the spinner 16, the irradiation arm 172 is made to pivot by the pivot driver 174 to a retracted position away from the position over the spinner 16 so as not to interfere the mounting and removal of the disc 4.

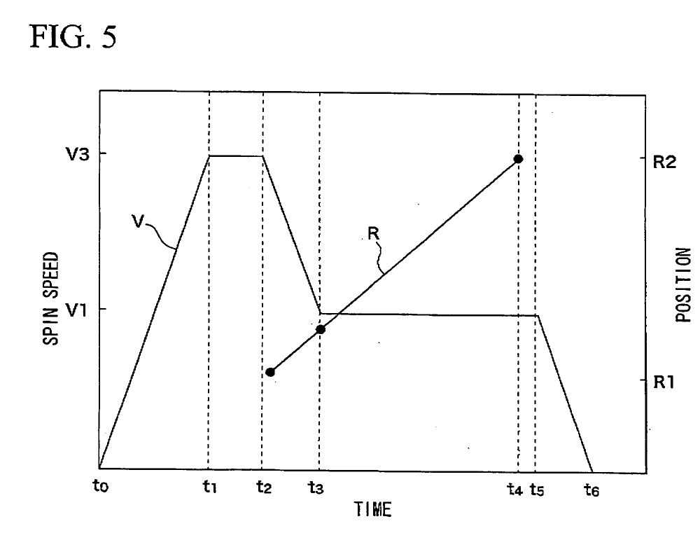

Now, also referring to FIG. 5, spinning of the disc 4 on the spinner 16 and the ultraviolet irradiation from the light irradiation unit 17 will be described. FIG. 5 is a time series graph showing a relationship between a spin speed V of the disc 4 spinning on the spinner 16 and an ultraviolet irradiation position R of the light irradiation unit. Time is plotted on a horizontal scale, the spin speed of the disc 4 is plotted on a vertical scale (left side) and the ultraviolet irradiation position of the disc 4 is plotted on the vertical scale (right side). The spin speed V is represented by the thick line, and the ultraviolet irradiation position R is represented by the thin, marked line. First, spinning begins at the time t0, and the spin speed is increased to a high spin speed V3 as a first spin speed. The high spin speed V3 is 2000 to 10000 (min−1), for example. Then, the high spin speed V3 is kept from time t1 to time t2. Although the time to keep the high spin speed V3 is typically several seconds, the high spin speed V3 is not necessarily kept. In this case, t1 and t2 indicate the same time. When spinning at high speed, the resin 3 circularly applied around the hole 2 spreads toward the outer circumference by centrifugal force, and spreads uniformly between the disc substrate 1 and the disc substrate 1′. However, thickness of the resin 3 rarely becomes uniform. Since the resin 3 spreads toward the outer circumference by centrifugal force, the thickness of the resin 3 becomes larger toward the outer circumference side.

At time t2, the spin speed V begins to decrease, and the spin speed V becomes low spin speed V1 at time t3. The low spin speed V1 is slower than the high spin speed V3, and is a spin speed at which the resin 3 is spread toward the outer circumference by centrifugal force becomes slow. The low spin speed V1 is, for example, several hundreds to 7000 (min−1). A second spin speed does not necessarily represent the low spin speed V1, but represents all the spin speed V reduced from the high spin speed V3. That is, the spin speed V which begins to decrease from the high spin speed V1 is also the second spin speed. When the spin speed V begins to decrease, ultraviolet irradiation will begin from the position R1 at the inner circumference side by the light irradiation unit 17. It is when the thickness of the resin 3 i.e., the distance between the disc substrate 1 and the disc substrate 1′ at the inner circumference side becomes a predetermined length, the irradiation of the ultraviolet light is started. Since the resin 3 is an ultraviolet curing resin, it begins curing when irradiated with ultraviolet light. The resin 3 may be completely cured by the ultraviolet light from the light irradiation unit 17. The resin 3 is not necessarily cured completely, but may be gelled, and cured to such an extent that the resin 3 does not spread over the outer circumference by centrifugal force caused by the subsequent spinning (i.e., thickness of the resin 3 does not become thinner).

While spinning at the low spin speed V1, the resin 3 in a position other than that irradiated with ultraviolet light continues spreading toward the outer circumference side by centrifugal force. When the thickness of the resin 3 at a position adjacent to the position where the resin 3 has been cured at the side of the outer circumference becomes thinner to a predetermined thickness, the irradiation arm 172 is made to pivot by the pivot driver 174 to move the irradiating section 171, i.e., the position where the resin 3 is irradiated with ultraviolet light, is shifted toward the outer circumference side, and resin 3 at that position is cured. In this manner, by shifting the position at which the resin 3 is irradiated with ultraviolet light from light irradiation unit 17 toward the outer circumference side while confirming that the thickness of the resin 3 has become a predetermined thickness, the resin 3 can be cured with uniform thickness. Actually, the time when the thickness of the resin 3 becomes a predetermined thickness is determined depending on viscosity of the resin 3, the spin speed V, and other factors. Thus, the shifting speed of the position at which ultraviolet light is irradiated from the light irradiation unit 17 toward the outer circumference side can be determined in advance. That is, the film thickness of the resin 3 can be kept more uniform by continuously shifting the ultraviolet irradiation position from the inner circumference side toward the outer circumference side while rotating the disc 4, and by adjusting the movement speed appropriately. The shift of the ultraviolet irradiation position toward the outer circumference side is achieved by the pivotal movement of the pivot driver 174, and the movement speed is also adjusted by the speed of the pivoting movement.

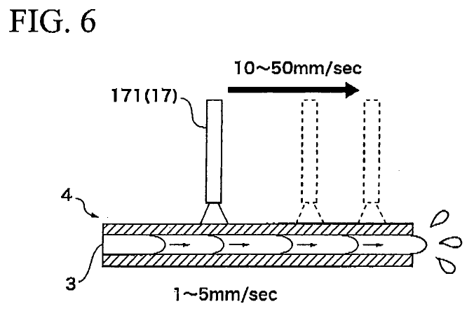

Here, also referring to FIG. 6, a relationship between the spread of the resin 3 toward the outer circumference side and the shift of the position at which the resin 3 is irradiated with ultraviolet light from the light irradiation unit 17 will be described. FIG. 6 is a schematic view illustrating a relationship between a spreading speed of the resin 3 due to spin of the disc 4 and a shifting speed of the ultraviolet irradiation position. Even when the disc 4 is rotated at low spin speed V1, the resin 3 spreads toward the outer circumference side by centrifugal force. The spreading speed of the resin 3 at that time varies depending on the viscosity and the spin speed of the resin 3, or on the predetermined distance between the disc substrates 1 and 1′, but typically is about 1 to 5 mm/sec. Whereas the speed at which the irradiating section 171 travels toward the outer circumference side, i.e., the speed at which the position of the resin 3 irradiated with ultraviolet light from the light irradiation unit 17 shifts, is preferably higher than the speed at which the resin 3 is spread, and for example, is 10 to 50 mm/sec. Then, as shown in FIG. 6, the resin 3 which receives ultraviolet irradiation slightly and tries to spread toward the outer circumference side is caught up to by the moving ultraviolet irradiation, and is cured in response to the ultraviolet irradiation. That is, the resin 3 influenced by the even slight ultraviolet irradiation spreads out toward the outer circumference side, and does not scatter from the outer circumference of the disc 4.

Since points at the side of the outer circumference on the disc 4 moves faster than those at the side of the inner circumference, when the irradiating section 171 is moved at a constant travelling speed, irradiation of the ultraviolet light decreased in amount as the irradiating section 171 moves toward the outer circumference side. However, since the amount of ultraviolet light decreases gradually, the degree of curing of the resin 3 does not vary rapidly and not cause unevenness in thickness of the resin 3. That is, the irradiation intensity of the ultraviolet light is determined such that the resin is gelled and cured even at the outer circumference side to an extent that it no more spread from the outer circumference by centrifugal force due to further spinning. Alternatively, the travelling speed of the irradiating section 171 may decrease as it moves toward the outer circumference side. In this case, the degree of curing of the resin 3 can be uniform at both the outer and inner circumferences. Alternatively, the irradiation intensity of the ultraviolet light may be increased as the irradiating section 171 moves toward the outer circumference side, and the travel irradiating section 171 may travel at a constant speed. In this case, the resin 3 can be cured uniformly with the controlled irradiation intensity of the ultraviolet light. When the film thickness of the resin 3 is tend to become thin as the irradiating section 171 approaches the outer circumference, it is required to increase the travelling speed of the irradiating section 171 as it approaches the outer circumference side. Also in this case, the curing state of the resin 3 can be controlled to increase the irradiation intensity of the ultraviolet light as the irradiating section 171 approaches the outer circumference. The irradiation intensity of the ultraviolet light may be controlled by altering generating amount of the ultraviolet light in an ultraviolet light source 176. When the irradiating section 171 has a lens mechanism, the irradiation intensity of the ultraviolet light may be controlled by adjusting the lens. Alternatively, the irradiation intensity of the ultraviolet light may be controlled by a vertical movement of the vertical driver 173. Referring again to FIG. 5, description on the spin of the disc 4 on the spinner 16 and the ultraviolet irradiation of the light irradiation unit 17 will be continued. The position R at which the resin 3 is irradiated with ultraviolet light by the light irradiation unit 17 is stopped at the position R2 before the light irradiation unit 17 reaches the outer circumference of the disc 4. Then, the spinner 16 keeps spinning at the low spin speed V1 until time t5 when the thickness of the resin 3 outside of a range cured in response to the irradiation of ultraviolet light, i.e., the resin 3 in the range where no ultraviolet light has been irradiated, obtains predetermined thickness. At the time t5, the spin speed V of the spinner 16 is reduced, and becomes 0 (zero) at time t6. While the spinner 16 keeps spinning at the low spin speed V1, the resin is scattering from the outer circumference of the disc 4. When the ultraviolet light irradiation unit reaches the outer circumference of the disc 4, a portion of the resin 3 that has been irradiated with ultraviolet light but has not cured begins scattering. The irradiation of the ultraviolet light by the light irradiation unit 17 stops when the irradiating section 171 reaches the position R2. The irradiation of the ultraviolet light may be stopped by stopping the generation of ultraviolet light in the ultraviolet light source 176. Alternatively, the irradiation of the ultraviolet light may be stopped by separating the irradiating section 171 from the disc 4 by vertical driver 173 to substantially eliminate irradiation of the ultraviolet light to the disc 4. Then, the irradiating section 171 and the irradiation arm 172 are retracted to a standby position by pivoting movement of the pivot driver 174. In this manner, the movement of the pivot driver 174 and the vertical driver 173 may cause the irradiating section 171 and the irradiation arm 172 that otherwise interfere the movement of the mounting or removal of the disc 4 to standby, and cause the irradiation to start or stop. As a result, the device configuration becomes simple and the operating time can be reduced. The height of the irradiating section 171 of the light irradiation unit 17 may be determined in advance suitable to irradiate ultraviolet light to the surface of the disc 4 mounted on the receiver 16a of the spinner 16. In this manner, since the disc 4 can be irradiated at a predetermined range only by the pivoting operation of the pivot driver 174 without operating the vertical driver 173, the operating time can be reduced.

Once the resin 3 is irradiated with ultraviolet light, the ultraviolet light absorbance characteristic, viscosity, and other characteristics of the resin 3 varies and it is thus difficult to mix the irradiated resin with new resin to re-use the same. Thus, the ultraviolet irradiation is stopped at the position R2 slightly before the irradiation unit reaches the outer circumference of the disc 4 so that the resin 3 at the outermost side is not irradiated with ultraviolet light. Spinning is controlled to prevent scattering of the irradiated resin due to further spinning of the disc 4. In this manner, mixing of the resin irradiated with ultraviolet light with the resin scattering from the disc 4 can be prevented. As described above, the resin 3 which receives slight ultraviolet irradiation is prevented from spreading toward the outer circumference and scattering from the outer circumference of the disc 4. Thus, mixing of the resin irradiated with ultraviolet light with the resin scattering from the disc 4 can be prevented.

As shown in FIG. 3, the resin 3 scattered from the disc 4 impinges on the wall of the coater house 40, naturally falls down and collected on the bottom surface of the coater house 40. At that time, air is sucked from the coater house 40 via the resin reservoir 42 and the suction pipe 41, when the suction unit 43 sucks air. The central portion of the coater house 40 is closed by the receiver 16a of the spinner 16. Thus, when air is sucked toward the suction pipe 41 from the circumference of the receiver 16a, downward air flow is formed around the disc 4. Further, air flow from the bottom surface of the coater house 40 to the suction pipe 41 is also formed. Therefore, the resin 3 scattering from the disc 4 is also influenced by the air flow to flow into the suction pipe 41. The resin 3 flown into the suction pipe 41 is collected on the bottom of the resin reservoir 42. Since the resin reservoir 42 includes an upper opening communicating with the suction unit 43, only air is sucked by the suction unit 43. The resin 3 is thus stored in the resin reservoir 42. Although only one suction pipe 41 is shown in FIG. 3, plural suction pipes 41 may be provided and connected to single or plural resin reservoirs 42. When the viscosity of the resin is especially high, providing plural suction pipes 41 on the bottom of the coater house 40 may facilitate collection of the resin 3 in the resin reservoir 42. The resin 3 collected in the resin reservoir 42 is taken out suitably and is re-used as resin.

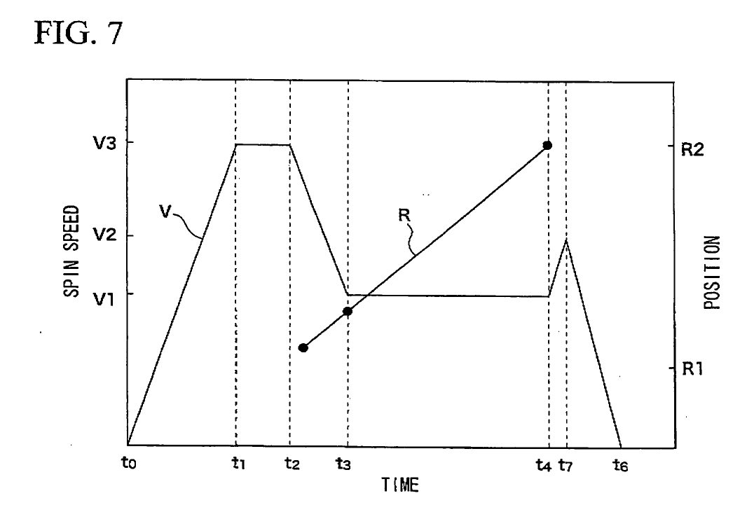

As shown in FIG. 7, the rotation may be stopped after the irradiation of the ultraviolet light is stopped and the spin speed V is once increased to the spin speed V2 of medium speed. FIG. 7 is a time series graph like that of FIG. 5 showing a relationship between a spin speed V of the disc 4 spinning on the spinner 16 and an ultraviolet irradiation position R of the light irradiation unit 17. Time is plotted on a horizontal scale, the spin speed of the disc 4 is plotted on a vertical scale (left side) and the ultraviolet irradiation position of the disc 4 is plotted on the vertical scale (right side). The spin speed V is represented by the thick line, and the ultraviolet irradiation position R is represented by the thin, marked line. As shown in FIG. 7, the spin speed V is increased to spin speed V2 at time t7 after the resin 3 is irradiated with ultraviolet light before the irradiation unit reaches the outer circumference and the resin 3 is cured. Thus, the resin 3 at the outer circumference which has not been cured can be rapidly made thin to improve working efficiency. The spin speed V2 is speed at which the cured resin does not scatter due to the spinning. Particularly when the spreading and curing of the resin 3 is a bottleneck in the operating process in the resin film forming device 100, even slight reduction in time may contribute to the improvement in working efficiency of the resin film forming device 100. The disc 4 is not necessarily irradiated with ultraviolet light while spinning at a certain low rotation speed V1. The disc 4 may alternatively be irradiated with ultraviolet light while the spin speed of the disc 4 is gradually reduced from the spin speed V3 to the spin speed V1. That is, the spin speed can be reduced from the high spin speed V3 to the low spin speed V1 during the time period in which the ultraviolet light is irradiated (from time t2 to time t4). In this case, no time t3 exists in the graph of FIG. 5 or FIG. 7, and the spin speed is reduced from V3 to V1 from during time t2 and time t4. Although the spin speed is reduced linearly with respect to the time in FIG. 5 or FIG. 7, the spin speed reduction is not necessary linear. During time t3 and time t4, the spin speed is not necessarily constant, but may be increased or decreased depending on the state of film thickness. Increase or decrease of the spin speed in this time period can control the film thickness of the disc 4 highly precisely.

Now, referring again to FIG. 1, description will be continued on the method of fabricating the disc 4 in which two disc substrates 1 and 1′ are bonded together in the resin film forming device 100. The disc 4 is placed in the receiver 18 by the transfer unit 15 from the spinners 16A and 16B. The transfer unit 15 has three arms and the angles among the arms correspond to the angles among a position in the receiving part 11a of the turn table 11 at which the disc 4 is taken out, the spinner 16 and the receiver 18. Thus, transfer of the disc 4 before spreading and curing of the resin 3 from the receiving part 11a to the spinner 16, and transfer of the disc 4 after spreading and curing of the resin 3 from the spinner 16 to the receiver 18 can be efficiently performed at the same time. The disc 4 temporarily placed in the receiver 18 is transferred to the receiving part of the turn table 20 by the transfer unit 19. By transferring the disc 4 to the turn table 20 from the spinner 16 via the receiver 18, even if timing difference is generated between the operation of the spinner 16 and the operation of the turn table 20, the resin film forming device 100 works without inconvenience. The receiver 18 and the transfer unit 19 are not necessarily provided, and the disc 4 may be transferred to the turn table 20 from the spinner 16 by the transfer unit 15.

The turn table 20 rotates intermittently by 90 degrees to transfer the disc 4 to the curing unit 21 and returns the disc 4 to the position at which the disc 4 is placed. Since the disc 4 is placed and removed at the same position on the turn table 20, a single transfer unit 19 can be used to place and remove the disc 4. The curing unit 21 irradiates the entire disc 4 with ultraviolet light so as to completely cure the resin 3 that has not received irradiation of the ultraviolet light by the light irradiation unit 17, and also completely cure semi-cured resin. Here, when the resin 3 is completely cured, it is solidified. The disc 4 with completely cured resin 3 is transferred to the turn table 22 by the transfer unit 19. The positional relationship of the receiver 18, the turn table 20 and the turn table 22 corresponds to the angle made by two arms of the transfer unit 19. For this reason, like the transfer unit 15, transfer of the disc 4 from the receiver 18 to the turn table 20 and transfer of the disc 4 from the turn table 20 to the turn table 22 can be efficiently performed at the same time.

The turn table 22 sends the disc 4 to the inversion unit 23 and the electric discharge unit 24 by rotating intermittently by 90 degrees. The inversion unit 23 inverts the disc 4 for later inspection depending on the state of the film formed on the disc 4. Then, ionized air is blown off from the electric discharge unit 24 to the upper and lower surfaces of the disc 4 to remove any dust or other material adhering on the surface of disc 4, thereby cleaning the surface. The disc 4 with clean surface is transferred to the inspection unit 26 by the transfer unit 25. The inspection unit 26 inspects the disc 4 as a product. The inspection unit 26 inspects, for example, misalignment between the disc substrate 1 and the disc substrate 1′ and existence of blemish. Since dust or other material is removed by the electric discharge unit 24, the dust or other material cannot be wrongly considered as blemish, or the disc substrates 1 and 1′ cannot be misaligned. Thus, reliability is improved.

The disc 4 inspected by the inspection unit 26 is transferred to the lifting stage 27 by the transfer unit 25. The positional relationship among the position at which the disc 4 is taken out on the turn table 22, the position of the inspection unit 26 and the position of the lifting stage 27 also corresponds to the angle made by the two arms of the transfer unit 25. In this manner, like the transfer units 15 and 19, transfer of the disc 4 from the turn table 22 to the inspection unit 26 and transfer of the disc 4 to the lifting stage 27 from the inspection unit 26 can be performed efficiently at the same time. The disc 4 is lifted by the lifting stage 27, made to abut the undersurface of the distal end of the arm of the transfer unit 28, and is sucked and held by the suction unit provided at the undersurface of the arm. The disc 4 sucked and held by the transfer unit 28 is transferred to the non-defective article table 29 if the disc 4 passed the inspection, and to the defective article table 30 if the disc 4 failed to pass the inspection. The discs 4 placed on the non-defective article table 29 are fed to subsequent processes and then shipped. The discs 4 placed on the defective article table 30 are processed as defective articles. In order to prevent that the height of the discs 4 transferred to the non-defective article table 29 or the defective article table 30 by the lifting stage 27 becomes too large, the discs 4 may be stacked on the non-defective article table 29 or the defective article table 30. Since the position at which the disc 4 is taken out from the resin film forming device 100 by the lifting stage 27 is high, subsequent processes are easy to conduct. Devices required with high positional accuracy, such as the turn table 11, the spinner 16 and the light irradiation unit 17 can be arranged at low, stable positions. However, the non-defective article table 29, the defective article table 30 and the like may be placed at the same height. In this case, the lifting stage 27 may be omitted.

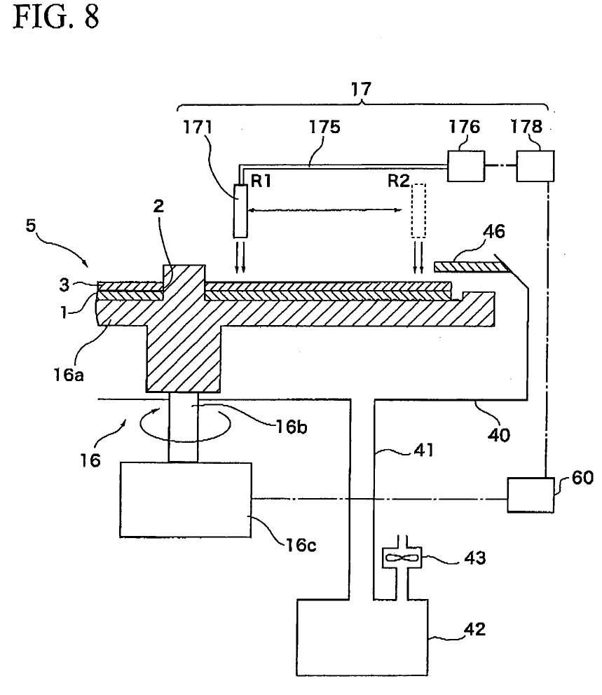

Next, with reference to FIG. 8, another example will be described in which the irradiation position is shifted by the light irradiation unit 17 from the inner circumference side toward the outer circumference side of a disc 5, and irradiation of light is stopped before the light irradiation unit 17 reaches the outer circumference. FIG. 8 is a partial cross section block diagram like FIG. 3, which illustrates the spinner 16, the light irradiation unit 17, the coater house 40 for catching resin 3 escaping from the disc 4 mounted on the spinner 16, a suction pipe 41 as the resin suction unit for sucking the resin 3 caught on the coater house 40, a resin reservoir 42, a suction unit 43, and a control unit 60. In FIG. 8, dashed line shows a communication channel of control signals. Although the disc 5 is shown in FIG. 8, which is different from the disc 4 fabricated by bonding two disc substrates together, disc 4 may also be used. The disc 5 is fabricated by forming a resin film 3 as a protective layer on a single disc substrate.

FIG. 8 is different from FIG. 3 in that a shutter 46 is provided to extend from a side wall of the coater house 40. The shutter 46 is for shutting the irradiation of the ultraviolet light from the irradiating section 171 of the light irradiation unit 17 onto the disc 5. That is, a board for blocking the ultraviolet light is provided as the shutter 46 between the irradiating section 171 and the disc 5 in a course of the irradiating section 171 at the side of the outer circumference from the position R2 at which the irradiation of ultraviolet light is stopped. By providing the shutter 46, even if the irradiating section 171 does not stop, or even if the irradiating section 171 is not moved upward apart from the disc 5, the shutter 46 blocks the ultraviolet light. In this manner, irradiation of the ultraviolet light to the disc 5 is stopped.

The shutter 46 may be rotatable with the side wall of the coater house 40 as a rotation support. The shutter 46 may also be foldable or retractable. With these configurations, the shutter 46 is preferably retracted so as not to interfere with the transfer of the disc 5 at the time of mounting and removal of the disc 5. Alternatively, the shutter 46 may only be disposed directly under the linear or circular path of the irradiating section 171. For this reason, the disc 5 may be inclined during mounting and removal so as not interfere with the shutter 46.

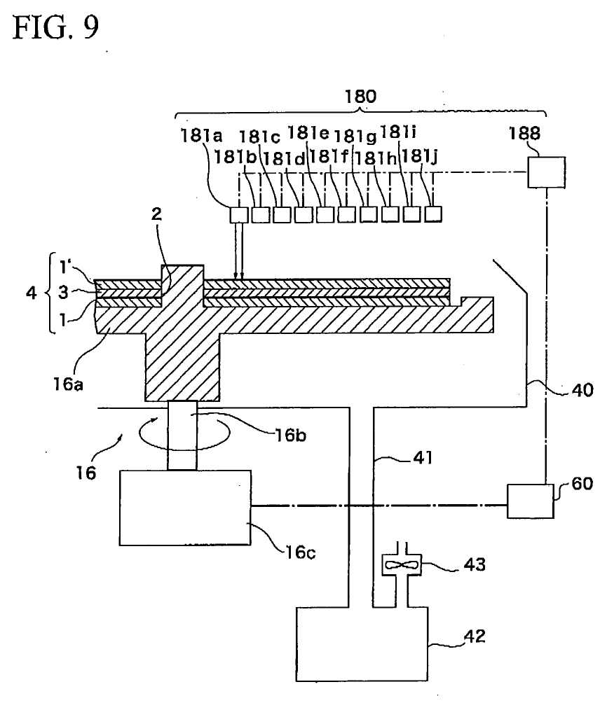

Next, with reference to FIG. 9, another example will be described in which the irradiation position is shifted by the light irradiation unit 180 from the inner circumference side toward the outer circumference side of a disc 4, and irradiation of light is stopped before the light irradiation unit 180 reaches the outer circumference. FIG. 9 is a partial cross section block diagram which illustrates the spinner 16, the light irradiation unit 180, the coater house 40 for catching resin 3 escaping from the disc 4 mounted on the spinner 16, a suction pipe 41 as the resin suction unit for sucking the resin 3 caught on the coater house 40, a resin reservoir 42, a suction unit 43, and a control unit 60. In FIG. 9, dashed line shows a communication channel of control signals. The light irradiation unit 180 is not structured to irradiate ultraviolet light while the irradiating section 171 is moved. In the light irradiation unit 180, closely arranged light emitting diodes (LEDs) 181a, 181b . . . turn on in sequence. With this configuration, the irradiation position is shifted from the inside toward the outside of the disc 4. Since the LED 181j of outermost periphery is positioned within the outer circumference of the disc 4, irradiation of the ultraviolet light stops within the outer circumference of the disc 4. Although FIG. 9 includes ten LEDs 181a to 181j, more LEDs may also be provided. The distance between each of the LEDs 181a to 181j is set to be, for example, 5 mm or less and may also be 2 mm or less. The LEDs turn on from the 181a at the inside of the disc 4. Continuous turning-on of the LEDs provides continuous irradiation. The irradiation position of the ultraviolet light is not continuously shifted in its precise sense. However, when multiple LEDs 181a to 181j emit light sequentially toward the outer circumference from the inner circumference side, the resin cures sequentially toward the outer circumference side from the inner circumference side. For this reason, it will move continuously substantially. The LEDs may be arranged linearly in the radial direction of the disc 4, or may be arranged diagonally, or in a checkerboard pattern. It suffices that the LED emits ultraviolet light while continuously moving in the radial direction of the disc 4. The ultraviolet light generator is not limited to the LED and other lamps may alternatively be used. The LED, however, is employed in the description herein.

In the light irradiation unit 180, each of the LEDs 181a to 181j is turned on every 0 second. That is, when the LED at the inner circumference side is turned off, the LED at the outer circumference side is turned on simultaneously. There may be slight interval of lighting time such as shorter than 0.1 seconds. The lighting time may also be slightly overlapped. In any case, the resin 3 is irradiated with ultraviolet light sequentially from the inner side toward the outer side so that the film thickness of the resin 3 becomes uniform at predetermined thickness. Turning-on and turning-off of the LEDs 181a to 181j are controlled by the LED controller 188. The LED controller 188 is preferably controlled by the control unit 60 to adjust timing with spinning of the spinner 16 or mounting of the disc 4. The light irradiation units 180 has a structure for sequentially turning the LEDs on and off from the inner circumference side toward the outer circumference side, so as to continuously shift the irradiation position from the inner circumference side toward the outer circumference side. With the structure, mechanical moving parts decrease in number, and thus the device can be simplified to reduce occurrence of mechanical malfunction. In a structure in which the irradiating section 171 travels via the irradiation arm 172 by pivotal movement of the pivot driver 174 as in the light irradiation unit 17, it is easy to continuously, in its precise sense, shift the ultraviolet irradiation position. It is easy to retract the irradiating section 171 and the irradiation arm 172 from the position above the spinner 16, and the disc 4 is easily mounted on and removed from the spinner.

It has been described that, in the resin film forming device 100 as shown in FIG. 1, the disc 4 is transferred to the processing units such as the resin supply unit 13 and the curing unit 21 via the turn tables 11, 20 and 22. However, the processing unit provided at the turn tables is not limited to those shown in FIG. 1. Instead of the turn tables, the disc 4 may be conveyed on, for example, a conveyor belt sequentially to the processing units.

It has been described in the resin film forming device 100 that the resin film is formed as an adhesive for bonding the disc substrates 1 and 1′ together with the resin 3 interposed therebetween. However, the resin film forming device 100 may be used as a device for forming a resin film as a protective layer of the disc substrate 1 as the disc 5 shown in FIG. 8. Alternatively, the resin film forming device 100 may be formed without a disc alignment unit 14 or other units. The process of spreading and curing the resin as described above may be used in a device for forming a protective layer. In this manner, the same advantageous effects can be obtained.

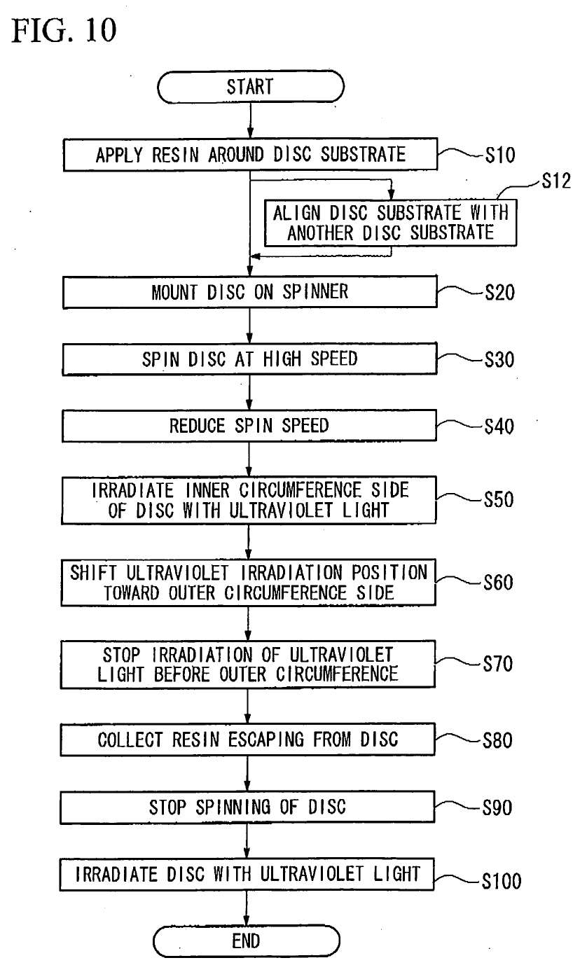

Here, with reference to FIG. 10, the method of forming the resin film will be summarized. FIG. 10 is a flow chart illustrating a main part of the method of forming a resin film according to the invention. First, the resin is circularly applied to the disc substrate around the hole (Step S10). Optionally, the disc substrate is aligned with a surface of another disc substrate on which the resin has been applied (Step S12). Alignment of the disc substrates may be omitted and Step S12 may be skipped. The disc with resin applied to the disc substrate, or the disc fabricated by disc substrates aligned with each other is mounted on the spinner (Step S20). Alternatively, the resin may be applied to the disc (Step S10) after the disc is mounted on the spinner (Step S20).

The disc is made to spin at high speed on the spinner (Step S30), and then the spin speed is reduced (Step S40). During or after the reduction in spin speed, irradiation of the ultraviolet light is started at a position at the inner circumference side of the disc (Step S50). The irradiation position of the ultraviolet light is shifted from the inner circumference side toward the outer circumference side of the disc (Step S60). Irradiation is stopped before the irradiation position of the ultraviolet light reaches the outer circumference of the disc (Step S70). The resin escaping from the disc while the disc is spinning is collected (Step S80). In the flow chart of FIG. 10, it is illustrated that the resin is collected (Step S80) after the irradiation of the ultraviolet light is stopped (Step S70). However, the resin may also be collected while the disc is spinning (Steps S30 to S70). Then, the disc is stopped spinning (Step S90). Note that, the spinning of the disc is not necessarily stopped completely, but may be reduced to such speed that the resin no more escapes by centrifugal force. Then, the entire surface of the disc is irradiated with ultraviolet light to completely cure the resin (Step S100). In a case where the resin irradiated with the moving ultraviolet light irradiation unit has been completely cured (Steps S50 to S70), the ultraviolet light in Step S100 may be irradiated only to the vicinity of the outer circumference where the resin remains uncured.

The above-described method of forming the resin film may be performed not in the resin film forming device 100 but a resin supply unit, a spinner, and an ultraviolet light irradiation unit of any structure. For example, independent devices may be used employed. The resin film may be formed by a program incorporated in a control device for controlling the above-described method of forming the resin film.

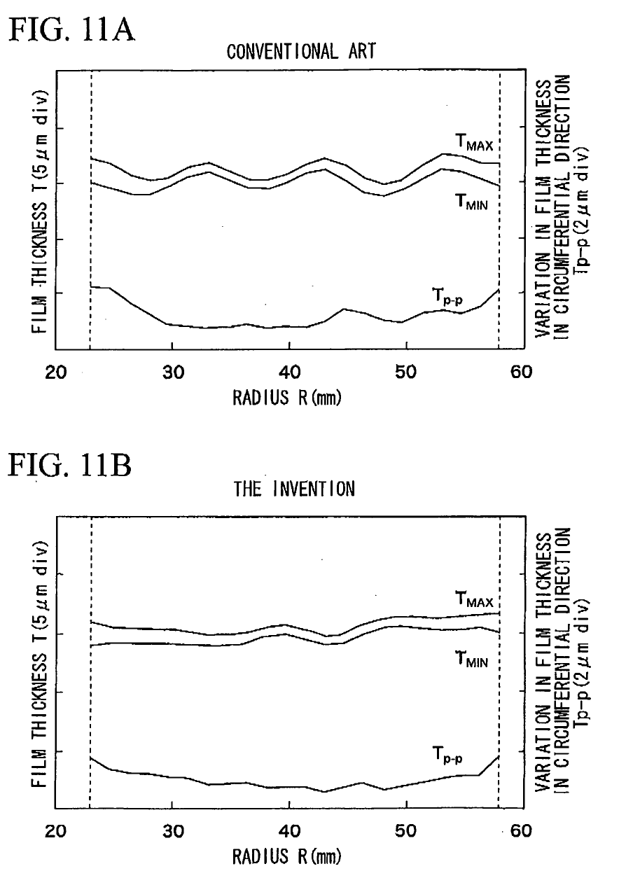

FIG. 11 shows distribution in thickness of the resin film formed by the device and method of forming the resin film according to the invention, and distribution in thickness of a resin film formed by conventional technology. FIG. 11A shows distribution at radius positions of the resin film on the disc formed in accordance with a conventional method. FIG. 11B shows distribution at radius positions of the resin film on the disc formed in accordance with the invention. In both FIGS. 11A and 11B, radius position on the disc is plotted on the horizontal scale, and the maximum and minimum values of the measured thickness of the resin film (left side) and difference between the maximum and minimum values of the resin film thickness (variation in thickness in the circumferential direction) are plotted on the vertical scale.

Here, the distribution at radius positions of the resin film on the disc formed in accordance with a conventional method means the distribution obtained in the following manner: as described in JP-A No. 2004-280927, the resin is circularly applied to a disc substrate around a hole; the resin is spread due to high-speed spinning of the disc substrate, then the disc substrate is made to spin at low spin speed at which the resin is no more spread out; at the same time, the resin of predetermined thickness is irradiated with ultraviolet light from the inner circumference side; after the resin is spread again while spinning the disc substrate at high speed, the resin of predetermined thickness is irradiated with ultraviolet light while the disc substrate spins at low spin speed; and the thickness of each radius positions is measured on a cocentric circle of the resin film formed by repeating the process. Whereas the distribution at radius positions of the resin film on the disc formed in accordance with the invention means the distribution of thickness of the formed resin film obtained in the following manner: after circularly applying resin to a disc substrate around a hole, the resin is spread due to high-speed spinning of the disc substrate; the spin speed is reduced to reduce the spreading speed of the resin; the disc substrate is irradiated with ultraviolet light, while the irradiation position is shifted from the inner circumference side to the outer circumference side so that the resin film obtains predetermined thickness; and irradiation is stopped before the irradiation unit reaches the outer circumference.

Even in the resin film formed by the conventional technology shown in FIG. 11A, variation in distribution of thickness is suppressed small. However, variation in the distribution of thickness of the resin film formed by the invention shown in FIG. 11B is still smaller, which means that the resin film has more uniform thickness. This is because the disc substrate is continuously irradiated with ultraviolet light from the inner circumference to the outer circumference while the resin is spread at high first spin speed, and then at low second spin speed. Therefore, the disc of the invention is preferably used as a disc with higher accuracy, such as a next generation high-capacity optical disc.

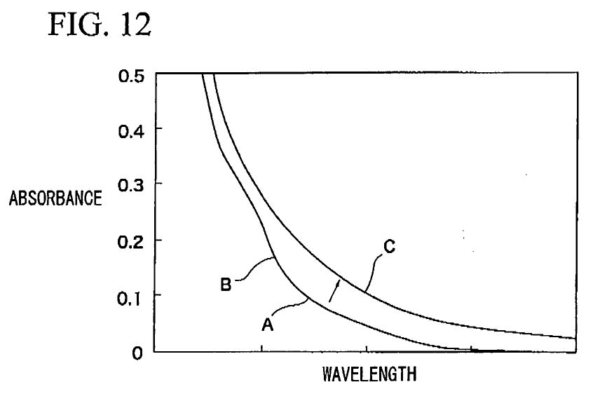

FIG. 12 is a graph illustrating comparison of absorbance characteristic of the resin in the ultraviolet region. The wavelength in the ultraviolet region is plotted on the horizontal scale, and absorbance is plotted on the vertical scale. In FIG. 12, curve A represents absorbance of unused resin, curve B represents absorbance of the resin escaping from the disc and collected in the resin film formation according to the invention, and curve C represents absorbance of the resin after being irradiated with ultraviolet light to such an extent that the resin remains uncured. The degree of curing reaction with absorbance of the ultraviolet curing resin can be determined from the graph. As the ultraviolet curing reaction progresses, the absorbance in the ultraviolet wavelength area changes. The absorbance of the resin irradiated with ultraviolet light shown by curve C changes greatly as compared with the absorbance of the resin before being irradiated with ultraviolet light. It is found that the ultraviolet curing reaction has progressed. As compared with the curve C, absorbance of the resin escaping from the disc and collected in resin film formation according to the invention of curve B did not change at all compared with absorbance of curve A, and curve B overlaps with curve A. Thus, it can be found that the resin escaping from the disc and collected in the resin film formation: process according to the invention did not undergo any ultraviolet curing reaction and thus can be re-used.

### INDUSTRIAL APPLICABILITY

As described above, a resin film forming device is provided in which escaping resin can be re-used while characteristics such as absorbance and viscosity of the resin remain static.

1. A resin film forming device, comprising:
a spinner on which a circular disc having a hole at the center thereof is mounted, the spinner making the disc spin about the hole;
a resin supply unit which applies resin onto the disc around the hole; and
a light irradiation unit which irradiates the resin on the disc mounted on the spinner with light to cure the resin, the light irradiation unit shifting a light irradiation position from an inner circumference side toward an outer circumference side of the disc mounted on the spinner, and stopping the light irradiation before the light irradiation unit reaches the outer circumference of the disc.

2. A resin film forming device according to claim 1, wherein the light irradiation unit continuously shifts the light irradiation position from the inner circumference side toward the outer circumference side of the disc mounted on the spinner.

3. A resin film forming device according to claim 1, wherein:
the spinner makes the disc spin at first spin speed to spread the resin applied around the hole, and then makes the disc spin at second spin speed slower than the first spin speed; and
the light irradiation unit begins irradiating the disc with light while the spinner spins the disc at the second spin speed.

4. A resin film forming device according to claim 1, further comprising a disc alignment unit which places, on the disc having thereon the resin applied by the resin supply unit, another disc from a side at which the resin is given.

5. A resin film forming device according to claim 1, further comprising a resin suction unit which sucks the resin escaping from the disc mounted on the spinner.

6. A resin film forming device according to claim 1, further comprising a curing unit which re-irradiates light on the resin which has been spread and irradiated with light by the light irradiation unit.

7. A resin film forming device according to claim 1, wherein
the light irradiation unit includes:
a light irradiation portion;
an arm which supports the light irradiation portion; and
a pivot driver which supports the arm and makes the arm pivot and travel from the inner circumference side toward the outer circumference side of the spinning disc.

8. A resin film forming device according to claim 1, wherein
the light irradiation unit includes:
a light irradiation portion;
an arm which supports the light irradiation portion;
a pivot driver which supports the arm and makes the arm pivot and travel from the inner circumference side toward the outer circumference side of the spinning disc; and
a vertical driver connected to the pivot drivel; for moving the arm upward to thus move the light irradiation portion upward when the light irradiation portion is moved toward the outer circumference of the disc.

9. A method of forming a resin film, comprising:
a process of mounting a circular disc having a hole at the center thereof on a spinner, and making the disc spin about the hole;
a process of applying resin onto the disc around the hole;
a process of irradiating the disc with light while shifting an irradiation position from an inner circumference side toward an outer circumference side of the disc mounted on the spinner; and
a process of stopping irradiation of light before the irradiation position reaches the outer circumference of the disc.
